(19) United States
(12) Patent Application Publication
(10) Pub. No.: US 2017/0189785 A1
(43) Pub. Date: Jul. 6, 2017

(54) PERSONAL EXCERCISE MEASURING SAFETY SYSTEM

(71) Applicant: BION INC., New Taipei City (TW)

(72) Inventor: Yi-Lun Chen, New Taipei City (TW)

(21) Appl. No.: 15/465,602

(22) Filed: Mar. 22, 2017

Related U.S. Application Data
(63) Continuation-in-part of application No. 14/941,200, filed on Nov. 13, 2015.

(30) Foreign Application Priority Data
Nov. 24, 2014 (TW) 103140585

(51) Int. Cl. A63B 71/00; B62J 99/00; H04N 7/18; G06T 7/70; A63B 24/00; A63B 71/06

(52) U.S. Cl. CPC A63B 71/0054; A63B 24/0062; A63B 24/0003; A63B 71/0622; H04N 7/185; G06T 7/70; B62J 99/00; A63B 2220/12; A63B 2071/0661; A63B 2220/35; A63B 2230/04; A63B 2230/30; A63B 2230/50; A63B 2220/17; B62J 2099/0013; B62J 2099/002; B62J 2099/0033

(57) ABSTRACT

A personal exercise measuring safety system is provided, which includes an image acquiring device, an exercise measuring device, a portable digital measuring device. The image acquiring device is configured on one portion of a bicycle by a fixator or configured on a selected portion of an exerciser. The portable digital measuring device electrically connected with the image acquiring device for receiving an image acquired by the image acquiring device. The portable digital measuring device selectively displays the image and/or transmits the image to a mobile communication device to display the image on the mobile communication device. The portable digital measuring device is further electrically connected with the exercise measuring device so as to receive and display the exercise information of the exercise measuring device.

This application is a continuation-in-part of Ser. No. 14/941,200 filed on Nov. 13, 2015, entitled “Personal Exercise Measuring Safety System”.

### BACKGROUND OF THE INVENTION

(a) Technical Field of the Invention

The present invention relates to a personal exercise measuring safety system, and more particularly, to a personal exercise measuring safety system using image recognition technique to analyze the environment when riding a bicycle or doing exercise.

(b) Description of the Prior Art

It is often that exerciser engaged in outdoor sports tends to focus on sports and ignore the surrounding environment or their own physiological conditions, and affects the exerciser's security.

Further, riding a bicycle has become a trend for many reasons such as sport and travel and has thus attracted more people to take part in it. However, in a crowded metropolitan area, riding a bicycle on the same road with other vehicles can be dangerous when there is heavy traffic.

A bicycle rider often needs to turn his/her head around to see if there is any vehicle approaching and to keep a safe distance. When turning around, the rider could often fail to notice any obstacles or vehicles ahead, and could encounter some dangerous situation when a reckless driver cuts in the same lane.

Besides, it takes a lot of effort to ride a bicycle under various circumstances, especially under a high-temperature condition. In such case, if no proper measure is taken to evaluate the environment and to monitor the health condition of the rider, the rider could be harmed from excessive bicycle riding.

In addition, prior art bicycle meters disclosed in patents such as Taiwan Patent No. 1289659 titled “Intelligent Meter”, Taiwan Patent No. 581016 titled “Cycling Computer Device” do not provide images regarding the riding environment. Although Taiwan Patent No. M446381 titled “Monitoring system for bicycle riding behavior” and Taiwan Patent No. M476291 titled “Multifunctional Intelligent Meter” did provide images on the meters, they fail to include environmental images for the rider to observe the environment and alarming information regarding various bicycle riding situations. Therefore, it is necessary to provide a personal exercise measuring safety system which can prompt the bicycle rider or the exerciser with the traffic condition around the rider or the exerciser and alarming information based on current conditions.

### SUMMARY OF THE INVENTION

To solve the previous technical problems, one objective of the present application is providing a personal exercise measuring safety system which can use image recognition technique to analyze the environment when riding a bicycle or doing exercise.

To achieve the aforementioned objective, the present application provides a personal exercise measuring safety system. The personal exercise measuring safety system includes an image acquiring device, an exercise measuring device, a portable digital measuring device and a power supply device. The exercise measuring device may be mounted on a selected position of a bicycle or a selected portion of a user. The portable digital measuring device is electrically connected with the image acquiring device so as to receive an image or information. The portable digital measuring device selectively displays the image or information, and/or provides a mobile communication device for receiving and displaying the image or information.

The portable digital measuring device may be a cycling computer device mounted on a bicycle by a fixator, a handheld electronic device adapted to be handheld by a user or a wearable electronic device adapted to be wore on a selected portion of a user. The exercise measuring device comprises a movement detection device electrically connected with the portable digital measuring device for detecting at least one of speed information and wheel rotation speed information of the bicycle. The exercise measuring device may comprise a physiological signal detection device electrically connected with the portable digital measuring device for detecting at least one of a number of steps taken, heart rate, blood pressure, and body temperature of the user.

As above described, the personal exercise measuring safety system acquires images from the image acquiring device and provides information regarding the around conditions to the rider or the exerciser. Therefore, the bicycle rider or the exerciser can obtain the real-time information of the environment when riding or doing exercise.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 illustrates a view of a personal exercise measuring safety system of the present invention;

FIG. 2A illustrates a view of a first embodiment of the present invention;

FIG. 2B illustrates a view of a second embodiment of the present invention;

FIG. 2C illustrates a view of a third embodiment of the present invention;

FIG. 2D illustrates a view of a fourth embodiment of the present invention;

FIG. 3A illustrates a view of the display of the first embodiment of the present invention;

FIG. 3B illustrates a view of the display of the second embodiment of the present invention;

FIG. 3C illustrates a view of the display of the third embodiment of the present invention;

FIG. 3D illustrates a view of the display of the fourth embodiment of the present invention;

FIG. 4, it is a view showing the personal exercise measuring safety system of the present invention with a portable digital measuring device is applied in a user during exercise; and

FIG. 5, it is a view showing the personal exercise measuring safety system of the present invention with a mobile communication device is applied in a user during exercise.

### DETAILED DESCRIPTION OF THE PREFERRED EMBODIMENT

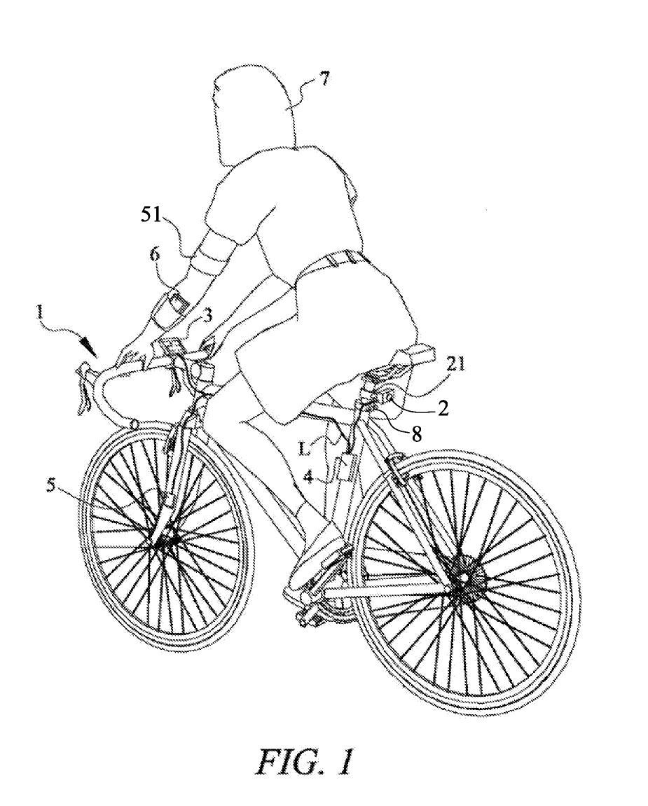

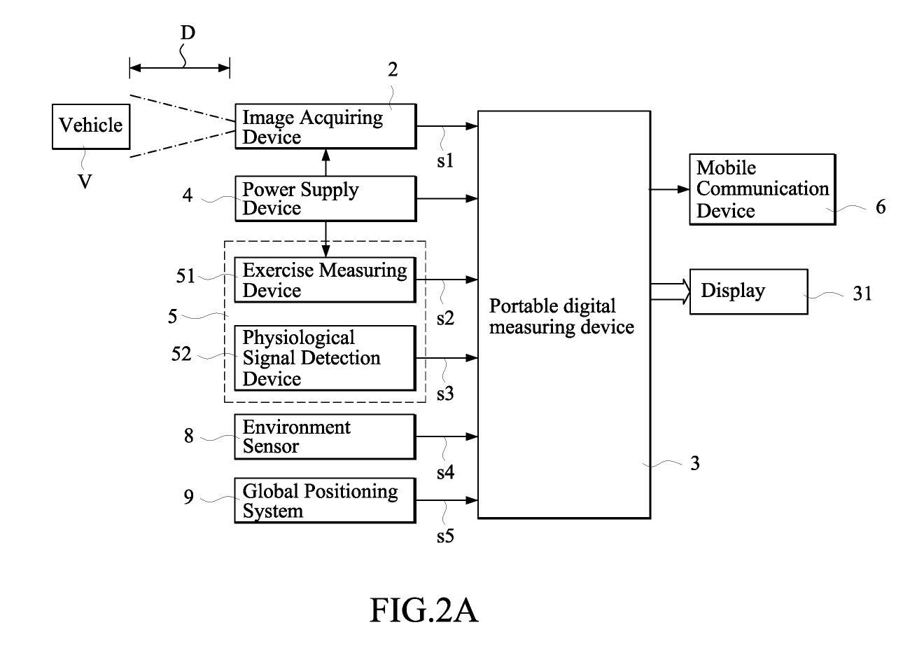

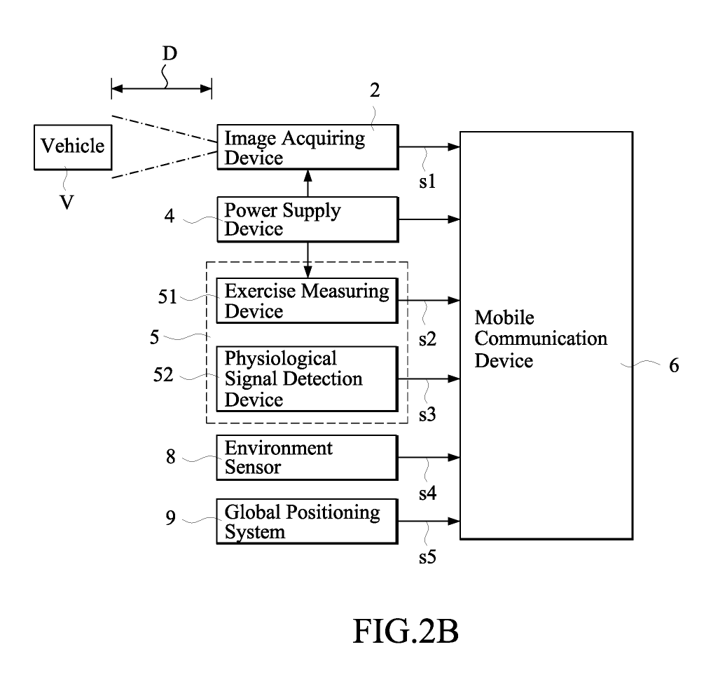

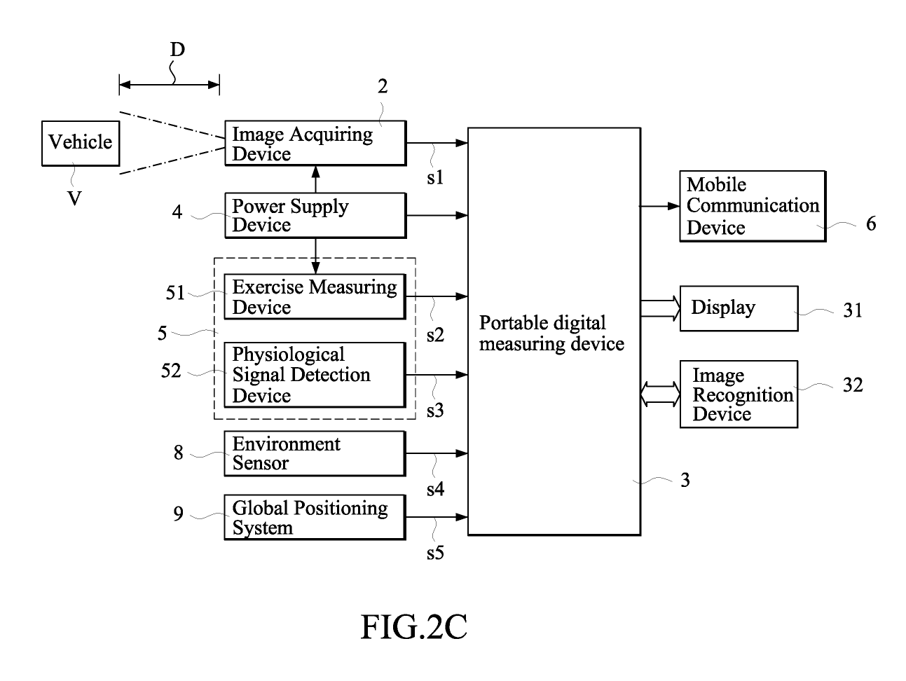

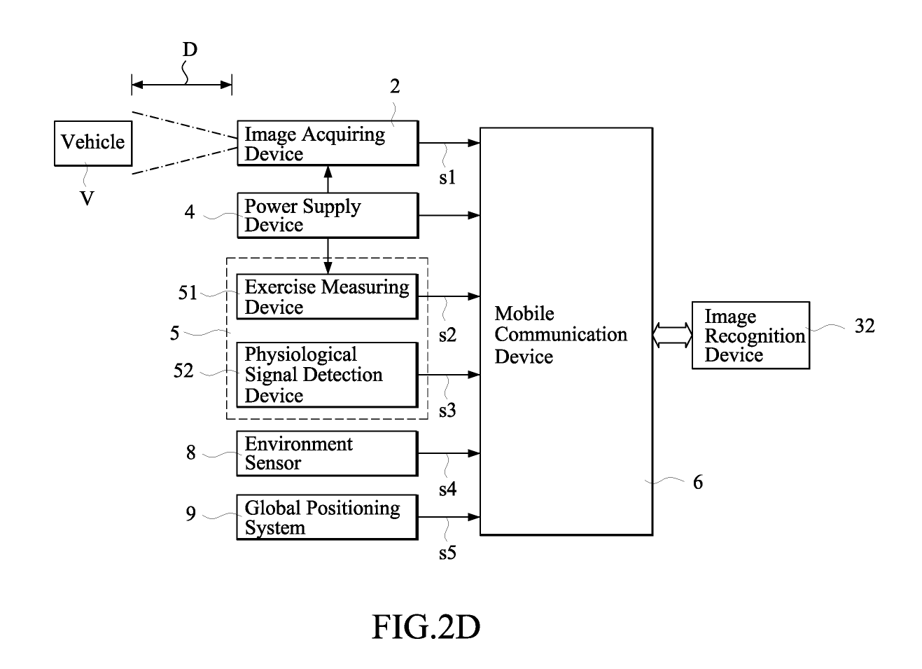

With reference to FIGS. 1 and 2A, FIG. 1 is a view showing the personal exercise measuring safety system of the present invention is applied in a bicycle 1, and FIG. 2A illustrates a functional circuit block diagram in accordance to a first embodiment of the present invention.

The personal exercise measuring safety system comprises an image acquiring device 2, a portable digital measuring device 3, a power supply device 4, and an exercise measuring device 5. The image acquiring device 2 is configured on one portion of the bicycle 1 or an electric bicycle by a fixator 21 for acquiring an image of an object (such as a vehicle V) behind or around the bicycle 1. The portable digital measuring device 3 is wirelessly connected with the image acquiring device 2 so as to receive an image s1 from the image acquiring device 2. The portable digital measuring device 3 selectively displays the image s1 on a display 31 of the portable digital measuring device 3 and/or transmits the image s1 to a mobile communication device 6 to display the image s1 on the mobile communication device 6. Preferably, the image s1 is displayed on the display 31 of the portable digital measuring device 3 and then the image s1 is transmits from the portable digital measuring device 3 to the mobile communication device 6, so that the image s1 is simultaneously displayed on the mobile communication device 6.

The portable digital measuring device 3 is electrically connected with the exercise measuring device 5 which comprises a movement detection device 51 and a physiological signal detection device 52. The exercise measuring device 5 may be mounted on a selected position of the bicycle 1 or a selected portion of a user 7.

Preferably, the portable digital measuring device 3 is wirelessly connected with the movement detection device 51 of the exercise measuring device 5 so as to receive and display at least one exercise information s2 detected by the movement detection device 51. The exercise information s2 may comprise one of speed information and wheel rotation speed information of the bicycle 1.

Preferably, the portable digital measuring device 3 is wirelessly connected with the physiological signal detection device 52 of the exercise measuring device 5 so as to receive and display at least one physiological information s3 including one of the numbers of steps taken, heart rate, blood pressure, and body temperature of the user 7. For example, the physiological signal detection device 52 may be a sphygmomanometer, blood glucose meter, thermometer, heart rate monitor strap, or wearable heart rate monitoring device.

The power supply device 4 is configured to provide electric power to the image acquiring device 2, the exercise measuring device 5, and the portable digital measuring device 3 through a power cord L. The image acquiring device 2, the exercise measuring device 5, and the portable digital measuring device 3 may be provided with a power supply device respectively. Alternatively, the image acquiring device 2, the exercise measuring device 5, and the portable digital measuring device 3 may be applied to an electric bicycle and are powered by a power supply device of the electric bicycle.

In the first embodiment, the portable digital measuring device 3 is a cycling computer device connected with the image acquiring device 2 (such as including a CCD image acquiring device and an image processor) through wired or wireless transmission means (such as Wi-Fi, Bluetooth) to acquire the image s1. Alternatively, the portable digital measuring device 3 may be a handheld electronic device adapted to be handheld by the user 7 or a wearable electronic device suitable to be wore on a selected portion of the user 7.

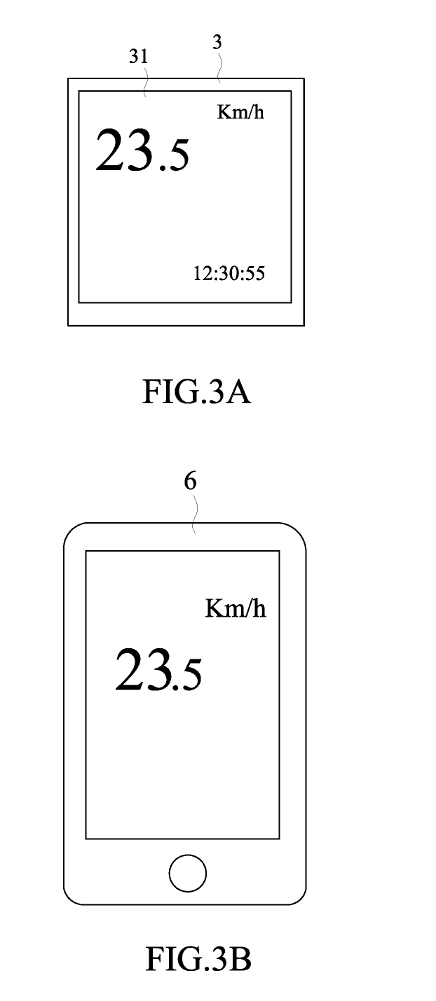

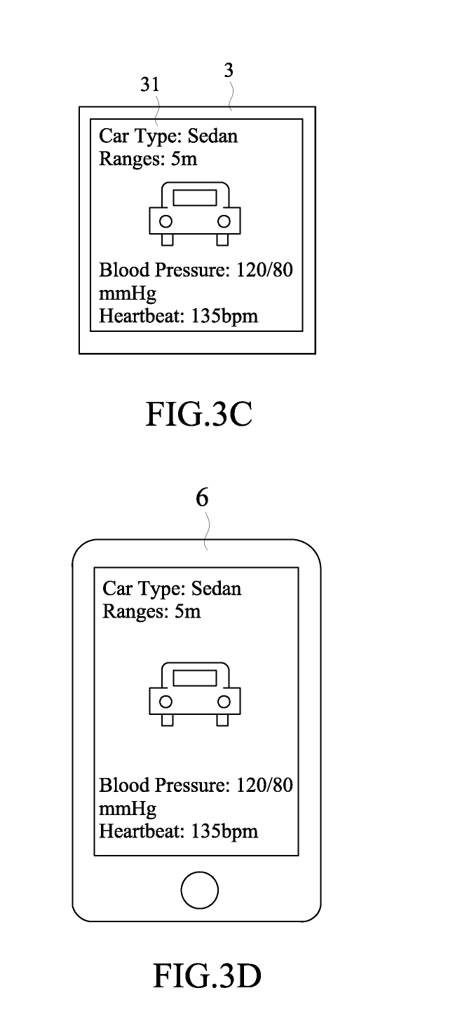

Before riding the bicycle 1, the user 7 can place the portable digital measuring device 3 at the bicycle stein and the image acquiring or information transmitting device 2 at the rear of the bicycle 1. When the user 7 starts to ride the bicycle 1, the display 31 of the portable digital measuring device 3 can display the exercise information s2, such as the speed information or wheel rotation speed information of the bicycle 1 detected by the movement detection device 51 of the exercise measuring device 5 as shown in FIG. 3A. The speed information or the wheel rotation speed information may be transmitted to the mobile communication device 6 for display. In addition, the image s1, the physiological information s3, the environment sensing information s4, and the positioning information s5 may be also displayed on the display 31 of the portable digital measuring device 3 and/or the mobile communication device 6.

The personal exercise measuring safety system further comprises an environment sensor 8 (such as thermometer, hygrometer, barometer, etc.) wirelessly connected with the portable digital measuring device 3. The environment sensor 8 can provide an environment sensing information s4 to the portable digital measuring device 3. Therefore, the portable digital measuring device 3 is capable of evaluating an exercise condition for the user 7 in accordance to the environment sensing information s4 and the exercise information s3 to determine whether the physical state of the user 7 is suitable for further riding. For example, the portable digital measuring device 3 can determine if there is a risk of heat stroke by obtaining and evaluating the body temperature of the user 7, the current ambient temperature, and humidity; if so, then the portable digital measuring device 3 can display heat stroke alarming information to remind the user 7.

Further, the personal exercise measuring safety system of the present invention includes a global positioning system 9 connected with the portable digital measuring device 3 for providing at least one positioning information s5 to the portable digital measuring device 3. In practice, the image acquiring device 2 may be integrated with the portable digital measuring device 3, the exercise measuring device 5 or the mobile communication device 6. The exercise measuring device 5 may be integrated with the portable digital measuring device 3 or the mobile communication device 6. The image acquiring device 2 and the exercise measuring device 5 may be integrated with the portable digital measuring device 3. The image acquiring device 2 and the exercise measuring device 5 may be integrated with the mobile communication device 6. The global positioning system 9 may be integrated with the image acquiring device 2, the exercise measuring device 5, the portable digital measuring device 3 or the mobile communication device 6. The physiological signal detection device 52 may be integrated with the image acquiring device 2, the exercise measuring device 5, the portable digital measuring device 3 or the mobile communication device 6.

Please refer to FIG. 2B for the second embodiment of the present invention. The second embodiment is different from the first embodiment in that the portable digital measuring device 3 of the first embodiment is replaced with a mobile communication device 6 which is a known telecommunication device having a telecommunication module capable of communicating with a remote telecommunication base station. The mobile communication device 6 is connected with the image acquiring device 2, the exercise measuring device 5, the environment sensor 8, and the global positioning system 9 in a wired or wireless manner. The exercise information s2 (such as speed information or wheel rotation speed information of the bicycle 1) may be displayed on the mobile communication device 6, as shown in FIG. 3B. In addition, the image s1, the physiological information s3, the environment sensing information s4, and the positioning information s5 may be also displayed on the mobile communication device 6.

In practice, the image acquiring device 2 may be integrated with the exercise measuring device 5 or the mobile communication device 6. The exercise measuring device 5 may be integrated with the mobile communication device 6. The image acquiring device 2 and the exercise measuring device 5 may be integrated with the mobile communication device 6. The global positioning system 9 may be integrated with the image acquiring device 2, the exercise measuring device 5 or the mobile communication device 6. The physiological signal detection device 52 may be integrated with the image acquiring device 2, the exercise measuring device 5 or the mobile communication device 6.

Please refer to FIG. 2C for the third embodiment of the present invention. The third embodiment is different from the first embodiment as shown in FIG. 2A in that the portable digital measuring device 3 of the third embodiment is further provided with an image recognition device 32. The portable digital measuring device 3 is capable of receiving image s1 from the image acquiring device 2 and then determining one of a type of a vehicle V (small sedan, motorcycle, or truck) acquired by the image acquiring device 2 and a distance D of the vehicle V in accordance with the acquired image s1 through an image recognition process of the image recognition device 32.

For example, as shown in FIG. 3C, when the portable digital measuring device 3 determines a sedan is coining up fast from the rear and quickly closing the distance D with the bicycle 1, the type of the vehicle V and the distance D of the vehicle V are displayed on the display 31 of the portable digital measuring device 3. At the same time, an alarm signal may be generated to remind the user 7 to keep safe distance from the vehicle V. In this embodiment, some physiological signals (such as blood pressure and heartbeat) may be displayed on the display 31 of the portable digital measuring device 3.

Please refer to FIG. 2D for the fourth embodiment of the present invention. The fourth embodiment is different from the second embodiment as shown in FIG. 2B in that the mobile communication device 6 of the fourth embodiment is further provided with an image recognition device 32. The mobile communication device 6 is capable of receiving image s1 from the image acquiring device 2 and then determining one of a type of a vehicle V (small sedan, motorcycle, or truck) acquired by the image acquiring device 2 and a distance D of the vehicle V in accordance with the acquired image s1 through an image recognition process of the image recognition device 32.

For example, as shown in FIG. 3D, when the mobile communication device 6 determines a sedan is coining up fast from the rear and quickly closing the distance D with the bicycle 1, the type of the vehicle V and the distance D of the vehicle V are displayed on the mobile communication device 6. At the same time, an alarm signal may be generated to remind the user 7 to keep safe distance from the vehicle V. In this embodiment, some physiological signals (such as blood pressure and heartbeat) may be displayed on the mobile communication device 6.

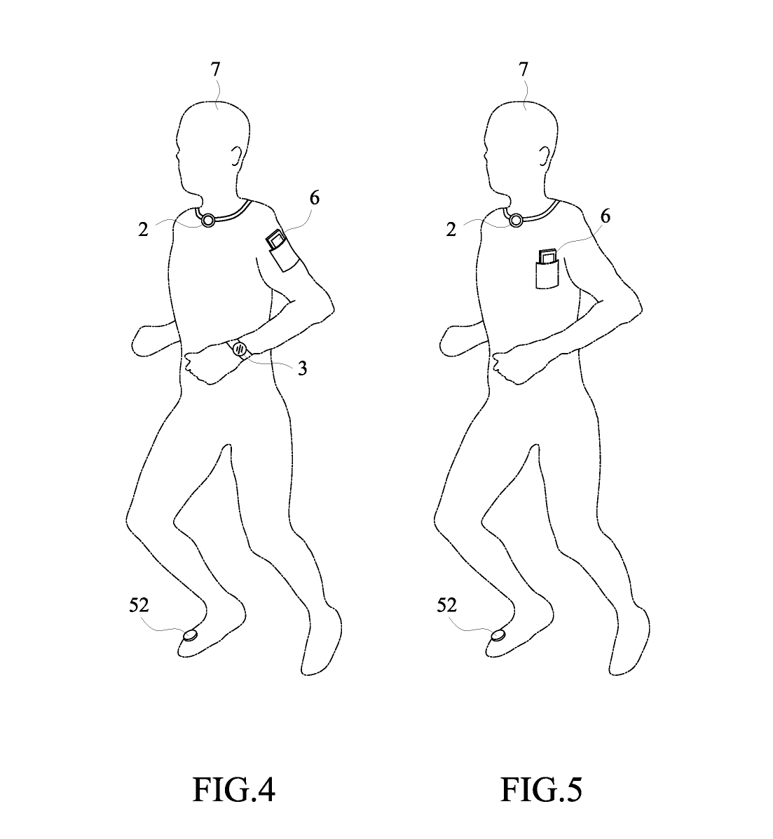

With reference to FIG. 4, it is a view showing the personal exercise measuring safety system of the present invention with a portable digital measuring device is applied in a user 7 during exercise. As shown in FIG. 4, an image acquiring device 2 is configured on a selected portion of the user 7 for acquiring an image around the user 7. Also, a portable digital measuring device 3 is wirelessly connected with the image acquiring device 2. The portable digital measuring device 3 is in a form of a wearable electronic device suitable to be wore on a selected portion of the user 7.

At least one physiological signal detection device 52, such as a pedometer, is configured on a selected portion of the user 7 and is wirelessly connected with the portable digital measuring device 3, so that at least one physiological information generated by the physiological signal detection device 52 may be displayed on the portable digital measuring device 3. An image acquired by the image acquiring device 2 may be transmitted to the portable digital measuring device 3 and then displayed on the portable digital measuring device 3. Further, the image is transmitted from the portable digital measuring device 3 to a mobile communication device 6, so that the image may be displayed on the mobile communication device 6.

With reference to FIG. 5, it is a view showing the personal exercise measuring safety system of the present invention with a mobile communication device is applied in a user 7 during exercise. As shown in FIG. 5, an image acquiring device 2 is configured on a selected portion of the user 7 for acquiring an image around the user 7. Also, a mobile communication device 6 is wirelessly connected with the image acquiring device 2.

At least one physiological signal detection device 52, such as a pedometer, is configured on a selected portion of the user 7 and is wirelessly connected with the mobile communication device 6, so that at least one physiological information generated by the physiological signal detection device 52 may be displayed on the mobile communication device 6. An image acquired by the image acquiring device 2 may be transmitted to the mobile communication device 6 and then displayed on the mobile communication device 6.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

I claim:

1. A personal exercise measuring safety system, comprising:
an image acquiring device for acquiring an image;
an exercise measuring device for detecting an exercise information; and
a portable digital measuring device electrically connected with the image acquiring device;
a mobile communication device electrically connected with the portable digital measuring device;
wherein the portable digital measuring device receives the image acquired by the image acquiring device and displays the image on a display of the portable digital measuring device;
wherein the image is further transmitted from the portable digital measuring device to the mobile communication device, such that the image is displayed on the mobile communication device; and
wherein the portable digital measuring device is further wirelessly connected with the exercise measuring device so as to receive and display the exercise information of the exercise measuring device.

2. The system as claimed in claim 1, wherein the portable digital measuring device is a cycling computer device mounted on a bicycle by a fixator.

3. The system as claimed in claim 1, wherein the portable digital measuring device is a handheld electronic device adapted to be handheld by a user.

4. The system as claimed in claim 1, wherein the portable digital measuring device is a wearable electronic device adapted to be wore on a selected portion of a user.

5. The system as claimed in claim 1, wherein the exercise measuring device is mounted on one of a selected position of a bicycle and a selected portion of a user.

6. The system as claimed in claim 1, wherein the exercise measuring device comprises a movement detection device electrically connected with the portable digital measuring device for detecting at least one of speed information and wheel rotation speed information of the bicycle.

7. The system as claimed in claim 1, wherein the exercise measuring device comprises a physiological signal detection device electrically connected with the portable digital measuring device for detecting at least one of a number of steps taken, heart rate, blood pressure, and body temperature of the user.

8. The system as claimed in claim 1, further comprising an environment sensor electrically connected with the portable digital measuring device, wherein the portable digital measuring device receives at least one environment sensing information from the environment sensor for evaluating an exercise condition for a user in accordance to the environment sensing information and the exercise information of the exercise measuring device.

9. The system as claimed in claim 1, further comprising a global positioning system electrically connected with the portable digital measuring device for providing at least one positioning information to the portable digital measuring device.

10. The system as claimed in claim 1, wherein the portable digital measuring device is further provided with an image recognition device for determining one of a type of an object and a distance of the object according to the image acquired by the image acquiring device.

11. The system as claimed in claim 1, wherein the image acquiring device is integrated with the exercise measuring device.

12. The system as claimed in claim 1, wherein the image acquiring device is integrated with the exercise measuring device and the portable digital measuring device.

13. A personal exercise measuring safety system, comprising:
an image acquiring device for acquiring an image;
an exercise measuring device for detecting an exercise information; and
a mobile communication device electrically connected with the image acquiring device;
wherein the mobile communication device receives and displays the image acquired by the image acquiring device; and
wherein the mobile communication device is further electrically connected with the exercise measuring device so as to receive and display the exercise information of the exercise measuring device.

14. The system as claimed in claim 13, wherein the mobile communication device is mounted on a bicycle by a fixator.

15. The system as claimed in claim 13, wherein the mobile communication device is a handheld electronic device adapted to be handheld by a user.

16. The system as claimed in claim 13, wherein the mobile communication device is a wearable electronic device adapted to be wore on a selected portion of a user.

17. The system as claimed in claim 13, wherein the exercise measuring device is mounted on one of a selected position of a bicycle and a selected portion of a user.

18. The system as claimed in claim 13, wherein the exercise measuring device comprises a movement detection device electrically connected with the mobile communication device for detecting at least one of speed information and wheel rotation speed information of the bicycle.

19. The system as claimed in claim 13, wherein the exercise measuring device comprises a physiological signal detection device electrically connected with the mobile communication device for detecting at least one of a number of steps taken, heart rate, blood pressure, and body temperature of the user.

20. The system as claimed in claim 13, further comprising an environment sensor electrically connected with the mobile communication device, wherein the mobile communication device receives at least one environment sensing information from the environment sensor for evaluating an exercise condition for a user in accordance to the environment sensing information and the exercise information of the exercise measuring device.

21. The system as claimed in claim 13, further comprising a global positioning system electrically connected with the mobile communication device for providing at least one positioning information to the mobile communication device.

22. The system as claimed in claim 13, wherein the mobile communication device is further provided with an image recognition device for determining one of a type of an object and a distance of the object according to the image acquired by the image acquiring device.

23. The system as claimed in claim 13, wherein the image acquiring device is integrated with the exercise measuring device.

24. The system as claimed in claim 13, wherein the image acquiring device is integrated with the exercise measuring device and the mobile communication device.
